(19) United States
(12) Patent Application Publication
(10) Pub. No.: US 2005/0185604 A1
(43) Pub. Date: Aug. 25, 2005

(54) Method and apparatus for transferring connectionless-oriented data packets

(75) Inventor: Gopal Agarwal, Bangalore (IN)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/785,255

(22) Filed: Feb. 23, 2004

(51) Int. Cl. H04L 5/22

(52) U.S. Cl. 370/299

(57) ABSTRACT

Disclosed is a method for providing reliability for unicast and multicast transmission of connectionless-oriented UDP packets over shared media, independently from applications relating to the transmission. The method includes the steps of periodically transferring from a transmitting side of data packets an SR packet, which includes information representing transmission data packets; determining if the data packets are lost depending on information of the SR packet if a receiving side of the data packets receives the SR packet from the transmitting side of the data packets, and transferring to the transmitting side of the data packets an RR packet, which includes information about a received data packet; periodically transferring an NACK packet, which includes information about the received data packet, if lost packets exist after the receiving side of the data packets periodically polls a receiver window; and transferring to the receiving side of the data packets an NACKR packet, which includes the lost data packets depending on information of the NACK packet, if the transmitting side of the data packets receives the NACK packet from the receiving side of the data packets.

### BACKGROUND OF THE INVENTION

1. Field of the Invention

The present invention relates to a protocol for transferring data packets, and more particularly to a method and an apparatus for transferring connectionless-oriented data, which can reliably transfer connectionless-oriented data packets between systems connected to each other through shared media.

2. Description of the Related Art

In general, a connection-oriented transmission control protocol (TCP) reliably transmits data between a transmitting side and a receiving side. However, a connectionless-oriented UDP provides only a basic checksum in order to ensure that UDP data are not damaged while being transferred. That is, the connectionless-oriented UDP does not ensure a reliable data transmission. Accordingly, a demand for a reliable transmission of connectionless-oriented data has increased.

### SUMMARY OF THE INVENTION

Accordingly, the present invention has been made to solve the above-mentioned problems occurring in the prior art, and a first object of the present invention is to enable a reliable transmission of connectionless-oriented data between systems connected to each other through shared media.

A second object of the present invention is to enable a reliable transmission of connectionless-oriented data independently from applications relating to transmission.

A third object of the present invention is to provide reliability for unicast and multicast transmission of connectionless-oriented UDP packets over shared media (e.g., LAN).

In order to accomplish the above mentioned objects, there is provided a method for transferring connectionless-oriented data packets between systems connected to each other through shared media, the method comprising the steps of: i) periodically transferring from a transmitting side of data packets an SR (Sender Report) packet, which includes information representing transmission data packets; ii) determining if the data packets are lost based on the information of the SR packet if a receiving side of the data packets receives the SR packet from the transmitting side of the data packets, and transferring to the transmitting side of the data packets an RR (Receiver Report) packet, which includes information about a received data packet; iii) periodically transferring an NACK (Negative Acknowledgement) packet, which includes information about the received data packet, if lost packets exist after the receiving side of the data packets periodically polls a receiver window; and iv) transferring to the receiving side of the data packets an NACKR (Negative Acknowledgement Reply) packet, which includes the lost data packets depending on information of the NACK packet, if the transmitting side of the data packets receives the NACK packet from the receiving side of the data packets.

### BRIEF DESCRIPTION OF THE DRAWINGS

The above and other objects, features and advantages of the present invention will be more apparent from the following detailed description taken in conjunction with the accompanying drawings, in which

FIG. 1 is a diagram showing a position of a Reliable Unicast & Multicast Protocol (RUMP) on an open system interconnection (OSI) layer;

FIG. 2 is a diagram showing RUMPs applied between systems connected to each other over shared media;

FIG. 3 is a view showing RUMPs applied between systems over shared media;

FIG. 4a is a diagram showing an internal structure of an RUMP according to one embodiment of the present invention;

FIG. 4b is a diagram showing a memory structure of the RUMP shown in FIG. 4a;

FIG. 5 is a diagram showing message exchange between clients provided in different systems;

FIG. 6 is a diagram showing a multicast data transmission procedure when a packet loss does not occur according to one embodiment of the present invention;

FIG. 7 is a diagram showing a procedure for confirming a packet loss through an SR packet during multicast transmission according to one embodiment of the present invention;

FIG. 8 is a diagram showing a procedure for confirming a packet loss through sequence numbers of received data during multicast transmission according to one embodiment of the present invention;

FIG. 9 is a diagram showing a unicast transmission procedure when a packet loss does not occur according to one embodiment of the present invention;

FIG. 10 is a diagram showing a procedure for confirming a packet loss through an SR packet during unicast transmission according to one embodiment of the present invention;

FIG. 11 is a diagram showing a procedure for confirming a packet loss through sequence numbers of received data during unicast transmission according to one embodiment of the present invention;

FIG. 12 is a diagram showing a client shutdown process according to one embodiment of the present invention;

FIG. 13 is a diagram showing one embodiment of a data transmission procedure between systems; and

FIG. 14 is a diagram showing another embodiment of a data transmission procedure between systems.

### DETAILED DESCRIPTION OF THE PREFERRED EMBODIMENT

Hereinafter, preferred embodiments of the present invention will be described in detail with reference to the accompanying drawings. Note that the same or similar components in drawings are designated by the same reference numerals as far as possible although they are shown in different drawings. In the following description of the present invention, a detailed description of known functions and configurations incorporated herein will be omitted when it may obscure the subject matter of the present invention.

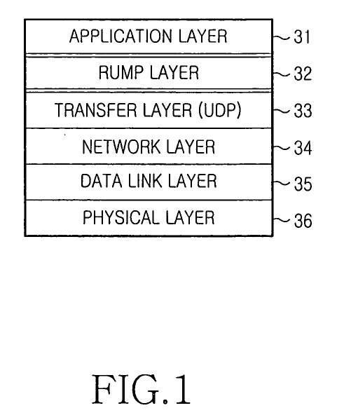

A transmission method according to the present invention provides reliability for unicast and multicast transmission of connectionless-oriented data packets (e.g. UDP data packets) between systems connected to each other through shared media (e.g. LAN). In the following description, the transmission method according to the present invention is referred to as a method employing an RUMP (Reliable Unicast & Multicast Protocol). A position of the RUMP on an OSI layer basis will be described with reference to FIG. 1.

As shown in FIG. 1, in an OSI network model including a physical layer 36, a data link layer 35, a network layer 34, a transfer layer (UDP) 33, and an application layer 31 for data transmission, an RUMP layer 32 of the present invention is positioned between the transfer layer 33 and the application layer 31.

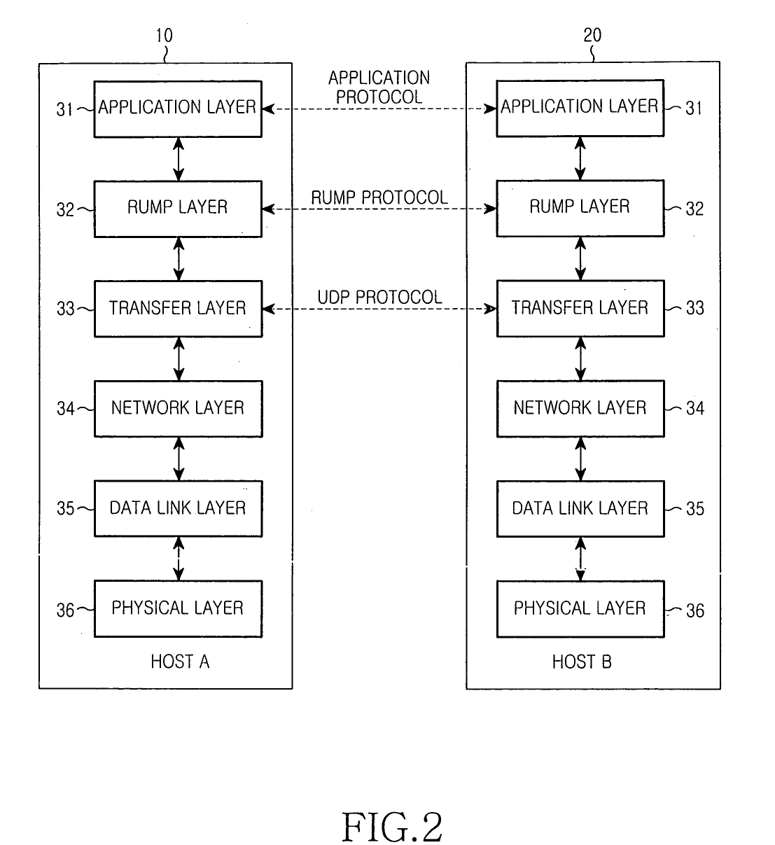

FIG. 2 is a diagram showing the RUMP applied between systems connected to each other over shared media. The RUMP layer 32 is a part of the transfer layer 33. However, for clear differentiation, the RUMP layer 32 is shown as a separate layer provided above the transfer layer 33. That is, the RUMP is positioned on the transfer layer 33 to provide reliability for unicast and multicast transmission of connectionless-oriented UDP data between systems connected to each other through shared media.

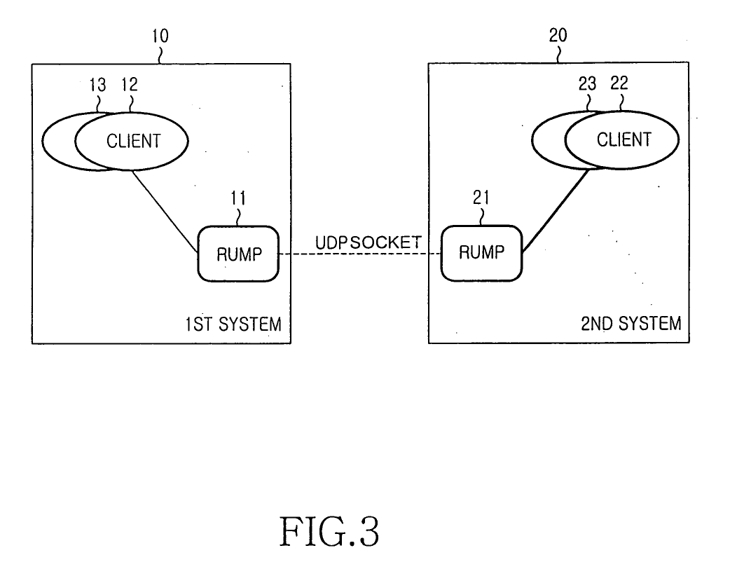

FIG. 3 is a diagram showing RUMPs 11 and 21 applied between first and second systems 10 and 20 requiring to reliably transmit UDP packet data.

Referring to FIG. 3, for full reliability it is necessary to incorporate the RUMP into each of the systems (e.g., the first system 10 and the second system 20) requiring the UDP reliability. Referring to FIG. 3, the RUMP is positioned on all systems over shared media requiring reliability for the unicast and multicast transmission of connectionless-oriented data. Accordingly, when transmitting the connectionless-oriented data between clients 12, 13, 22 and 23, the connectionless-oriented data can be reliably transmitted through the RUMP without requiring clients 12, 13, 22 and 23 to directly communication with each other. That is, a system which does not have a RUMP may allow clients to transmit/receive UDP packets to/from each between the clients, but may not provide reliable transmission which is independent from client characteristics. Here, the clients stand for a predetermined program, a predetermined service, a predetermined object, a predetermined application, etc.

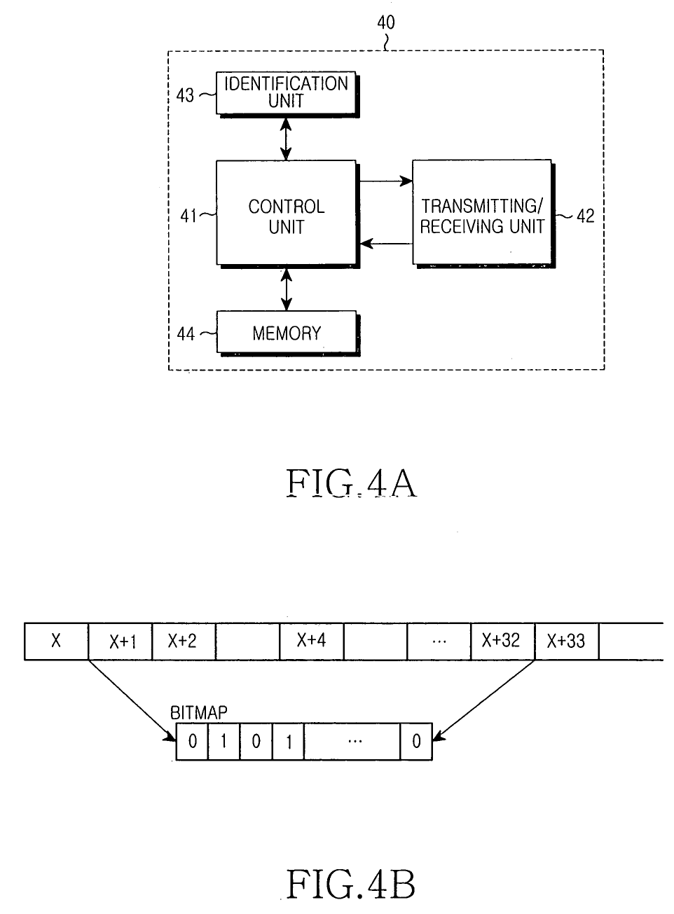

FIGS. 4a and 4b are diagrams showing a structure of an RUMP 40. As described above, the RUMP 40 can be used over shared media (e.g., local area network (LAN)) in order to provide reliability for unicast and multicast UDP packet transmission. In addition, the RUMP 40 is realized between the transfer layer 32 and the application layer 31. The structure of the RUMP will be described with reference to FIGS. 4a and 4b:

The RUMP 40 includes a control unit 41, a transmitting/receiving unit 42, an identification unit 43, and a memory 44. The control unit 41 manages transmitting states of clients depending on an activating state of the clients. Also, whenever transmission data suffers losses, the control unit 41 re-transmits the transmission data to destination clients. The transmitting/receiving unit 42 is connected to the control unit 41 and transmits/receives data between related clients. The identification unit 43 detects the transmitting states and identifications of the corresponding clients based on transmitted/received data.

The memory 44 provides a client table for updating client information and a bitmap for representing transmitting state information of the clients by operating depending on the activating state of the clients. At this time, it is possible to detect transmitting state information of each client by means of the identifications of the clients based on the client table and the bitmap. FIG. 4b is a diagram showing a bitmap having a size of 32 bits, which can represent 32 slot states at a time.

Hereinafter, an operation of the RUMP will be described with reference to FIGS. 4a and 4b. The control unit 41 detects whether or not the clients are activated. Also, the control unit 41 detects data transmitting/receiving states of the clients. If a specific client is activated to transmit data, the RUMP, which manages a system including the specific client, registers an identification of the specific client and an initial sequence number to be used for data transmission in the client table. Also, the RUMP reports the identification of the specific client and the initial sequence number to a second RUMP of a second system related to the specific client in such a manner that the second RUMP of the second system updates its corresponding client table. Accordingly, if the RUMP receives a data transmission request from the activated-specific client, the control unit 41 adds the initial sequence number of the corresponding client, which is received from an identification, to a data packet to be transmitted, so that the data packet is transferred. Meanwhile, if the RUMP receives data of a predetermined client from an external system, the control unit 41 detects whether of not the predetermined client identification in relation to or identical to a client identification of the received data is stored in the client table of the memory 44 by using the identification unit 43. If the client table shows that a client corresponding to the received data has been activated, the RUMP decides the receiving state by comparing a sequence number corresponding to the client with a sequence number of the received data.

Meanwhile, clients synchronize with RUMPs whenever a client is activated. The reason that the clients synchronize with the RUMP depending on the activating state of the clients is that the RUMP manages a multicast peer list for all of active-related client members included in a multicast group. That is, the RUMP manages a client list by identifying each of clients in relation to transmission, so that the RUMP can provide reliability for an unicast transmission or an multicast transmission, which is independent from client characteristics.

Hereinafter, four packet types, which are defined for data communication between an RUMP and a client, will be described.

First, when a client activates within a system, the RUMP receives an activation signal from the client. In contrast, when the client deactivates, the RUMP receives a deactivation signal. When the client activates within the system, the RUMP receives a client identification, a payload, and a destination address from the client. Also, the client waits for a payload of a packet to be transmitted thereto and a source address of the packet from the RUMP.

First, a US packet, which is an activation signal packet to be transferred to the RUMP when the client activates within a system, is represented in following Table 1.

TABLE 1

Command
Client id
Multicast-group Address

As represented in Table 1, the US packet includes command information (Command) of an activation signal, client identification (Client id) information, and a multicast-group address (Multicast-group Address).

Next, a DS packet is will be described with reference to the following Table 2.

TABLE 2

Command
Client id

Table 2 represents a structure of the DS packet, which is a deactivation signal packet transferred to the RUMP when the client deactivates from the system. As represented in Table 2, the DS packet includes command information of the deactivation signal and client identification information.

Tables 2 and 3 represent structures of data communicated between clients after a communication state between the RUMP and the client is set.

TABLE 3

Command
Client-id
Destination Address
Payload Size
Payload

TABLE 4

Command
Source Address
Payload Size
Payload

There are six type packets used for making communication between RUMP peers. The six type packets commonly include a common header having a structure represented in following Table 5. The common header includes a client identification in order to identify a plurality of clients which are activated in the system as necessary. Accordingly, the instances of the RUMPs may support a plurality of clients.

TABLE 5

Type
Client id

Hereinafter, the six type packets having the common header will be described. First, an SR (Sender Report) packet is exchanged among RUMPs running on a plurality of systems with a predetermined interval established depending on a level of congestion in shared media. The SR packet is represented in following Table 6.

TABLE 6

Next Sequence Number
The number of packets

The SR packet is transferred by an RUMP of a transmitting system when RUMPs running on a plurality of systems transmit or receive data. A packet, which is transferred by an RUMP of a receiving system in order to respond to the SR packet, is an RR (Receiver Report) packet. The RR packet is represented in Table 7.

TABLE 7

Next Sequence Number
Acknowledge Sequence Number
Windows Lowest Sequence No
BITMAP (for packets received)

The RR packet is sent by an RUMP peer in response to the received SR packet. The RR packet is sent to an RUMP peer which has transferred the received SR packet.

In addition, an ACK (Acknowledgement) packet is used by an RUMP only during an initial handshake mechanism in order to establish a three-way handshake between RUMP peers. A structure of the ACK packet is represented in Table 8.

TABLE 8

Acknowledge Sequence Number

Also, a DATA packet (data packet) is sent to one RUMP peer and to a plurality of peers by another RUMP peer depending on a destination address transferred from a client or a user. A structure of the DATA packet is represented in Table 9.

TABLE 9

Sequence Number
Data (payload)

Furthermore, an NACK (Negative Acknowledgement) packet is sent by an RUMP peer in order to represent negative ACK for packets which are not received from the other RUMP peer or a plurality of peers thereof. Also, each NACK packet is separately sent to each peer which has transferred the packets which are not received.

TABLE 10

Lowest lost Sequence Number
Bit mask of the following lost packets

An NACKR (Negative Acknowledgement Reply) packet is sent by one RUMP peer to another RUMP peer which has transferred the NACK packet. The NACKR packet includes all packets which are reported by the another RUMP peer, which has transferred the NACK packet, as missed packets. A structure of the NACKR packet is represented in following Table 11.

TABLE 11

Lowest received sequence number
Bitmask of the following repair
packets
Data/payload size
Data/payload
(‘payload size’ & ‘payload’
combination)

As described above, the six type packets used for making communication between RUMP peers have been described. Hereinafter, timers used for data communication will be described.

Six timers are used for an RUMP. Hereinafter a function of each timer will be described.

(1) SR Timer (Hereinafter, Simply Referred to as ‘SRT’)

An SRT is used when an RUMP transmits an initial SR packet. At this time, the RUMP periodically transfers the SR packet for a predetermined time established by means of the SRT.

(2) RWP (Received Window Poll) Timer (Hereinafter, Simply Referred to as ‘RWPT’)

An RWPT sets a time required by a receiver in order to receive a predetermined packet. Accordingly, a value of the SRT is larger than that of the RWPT.

(3) SR Retransmission Timer (Hereinafter, Simply Referred to as ‘SRRT’)

An SRRT is used when an RUMP retransmits the SR packet. The RUMP periodically retransmits the SR packet for a predetermined time established by means of the SRRT.

(4) NACK Retransmission Timer (Hereinafter, Simply Referred to as ‘NACKRT’)

An NACKRT is used when an RUMP retransmits the NACK packet. The RUMP periodically retransmits the NACK packet for a predetermined time established by means of the NACKRT.

(5) Initial Request Timer (Hereinafter, Simply Referred to as ‘IRT’)

An IRT is used when an RUMP transmits a predetermined “SR” packet.

(6) ACK Timer (Hereinafter, Simply Referred to as ‘ACKT’)

An ACKT is used when an RUMP transmits the ACK packet. The RUMP periodically retransmits the ACK packet for a predetermined time established by means of the ACKT.

Hereinafter, four parameters used by an RUMP in relation to maximum retransmission will be described.
(1) maximum NACK retransmission (hereinafter, simply referred to as ‘M1’)
(2) maximum SR retransmission (hereinafter, simply referred to as ‘M2’)
(3) maximum initial requests (hereinafter, simply referred to as ‘M3’)
(4) maximum ACK requests (hereinafter, simply referred to as ‘M4’)

Reliability may be improved by adjusting the ten configurable parameters described above. The ten configurable parameters are inter-related as shown below in order to maximize the required reliability.

A total time represented as “maximum SR retransmission×SR retransmission timer” must be less than a value of “SR timer” (i.e., M2×SRRT<SRT).

A total time represented as “maximum NACK retransmission×NACK retransmission timer” must be less than a value of “RWP timer” (i.e, M1×NACKRT<RWPT).

The value of the SR timer must be greater than that of the RWP (i.e., SRT>RWPT).

Furthermore, the bit map having a size of 32 bits is established between RUMP peers. A value ‘1’ shown in the bitmap represents a lost packet. If a bit k (1≦k≦32) is set as ‘1’, a packet having a sequence number corresponding to the bit k is lost.

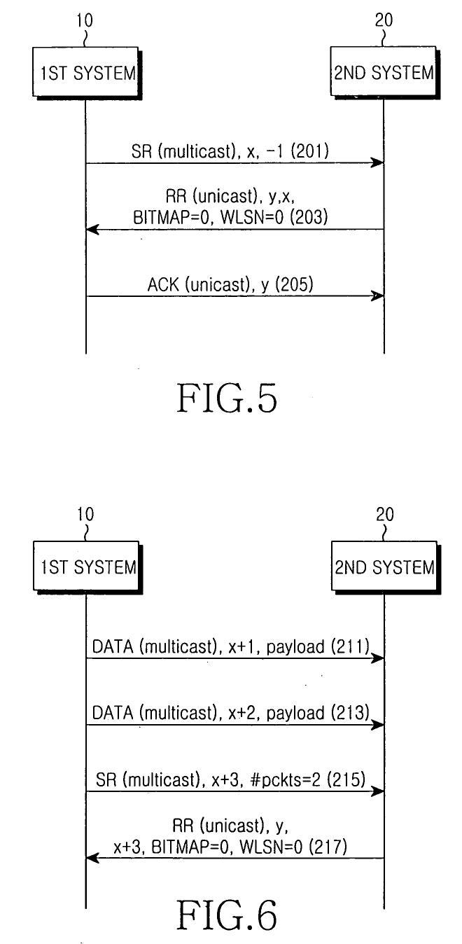

Hereinafter, multicast transmission and unicast transmission will be separately described according to one embodiment of the present invention. First, a handshake operation will be described with reference to FIG. 5.

Referring to FIG. 5, upon receiving an up signal from a client requesting a registration for transmitting data, the RUMP 11 of first system 10 registers a list in relation to the clients and an initial sequence number to be used for transmitting the data.

That is, whenever the clients 12 and 13 to be activated come up into the first system 10, the clients 12 and 13 individually send up signals to the RUMP 11 so as to be registered as activated clients. Also, corresponding RUMP transfers a type of a client requesting the registration, an identification of the client requesting the registration, and a sequence number to be used for a next data packet to an RUMP peer thereof through shared media. In particular, the RUMP 11 notifies the RUMP peer of a next sequence number and a client activated between systems over shared media, by using the SR packet and the RR packet. Also an ACK packet is transferred to an already-activated system in order to acknowledge that the RR packet has been received, so that a registration procedure using the three way handshake has been finished. Hereinafter, a description mentioned above will be described in more detail.

If the RUMP 11 of the first system 10 receives an up signal from a predetermined client which is newly activated, the RUMP 11 sends an SR packet, which includes an identification of the predetermined client and a next sequence number to be used, to the RUMP 21 of the second system 20 in step 201.

The SR packet is transferred to a multicast group in relation to the client type by N times with an interval of t seconds required by a member of the multicast group in order to send an RR packet as a response to the SR packet after receiving the SR packet. That is, it is assumed that all members of the multicast group have finished a three way handshake after ‘N×t’ seconds. At this time, ‘N’ and ‘t’ are adjustable parameters. Accordingly, each RUMP peer maintains a state flag representing whether or not an initial registration procedure has been finished by using a list of a group member consisting of clients, a next sequence number established for each client, and the three way handshake.

In addition, the SR packet is transferred on every expiry of ‘initial request timer’ until the ‘maximum initial request’ count is reached. At this time, a next sequence number included in the SR packet can be set as any predetermined value except for ‘0’. The number of packets include in the SR packet is set as ‘−1’. At this time, the number of the packets ‘−1’ represents an initial handshake mechanism. The RUMP 21 of the second system 20 sends an RR packet in response to the SR packet to the first system 10, which has transferred the SR packet, through a unicast transmission in step 203. At this time, although the first system 10 performs a multicast transmission, systems which have received a multicast packet respond to a system, which has transferred the SR packet through the multicast transmission, through the unicast transmission. A next sequence number of the systems included in RR packet transferred by the systems can be set as any predetermined value except for ‘0’. An ACK sequence number included in the RR packets is a next sequence number included in the SR packet transferred from the first system. In addition, a BITMAP and a WLSN (Window's Lowest Sequence Number) in the RR packet are set as ‘0’. Thereafter, the RUMP 11 of the first system transfers an ACK packet as a response to the RR packet, which has been received from the second system 20 in step 205. At this time, acknowledged sequence numbers of systems are transferred to corresponding systems. If the RUMP 21 of the second system does not receive the ACK packet, the RUMP 21 retransmits RR packets on every expiry of ACKT until the ‘maximum ACK request’ count is reached. Such registration procedure described above is required only for obtaining an initial sequence number used for connectionless-oriented data transmission between systems, in detail, between related clients, not for establishing a connection between peers.

As described above, under a condition representing that a newly-activated client and an already-activated client are registered with each other by a handshake mechanism between the newly-activated client and the already-activated client through an RUMP of the present invention, there are three cases showing transmission of a packet having a payload. A first case shows that a packet loss does not occur while transferring the packet between RUMP peers, a second case shows that the packet loss is confirmed by an SR packet transferred from the first system, and a third case shows that packet loss is confirmed by a sequence number of a data received from the first system. First, the first case in which the packet loss does not occur while transferring the packet between the RUMP peers will be described with reference to FIG. 6.

FIG. 6 is a diagram showing a multicast data transferring procedure according to one embodiment of the present invention. It is assumed that the packet loss does not occur. At this time, the first system and the second system detect whether or not their clients are activated and detect a sequence number to be used by exchanging an SR packet and an RR packet between RUMP peers thereon.

Referring to FIG. 6, the RUMP 11 of the first system 10 transfers data packets to the RUMP 21 of the second system 20 through the multicast transmission in step 211. Although only the second system 20 is shown in FIG. 6, the second system 20 stands for a plurality of systems including clients related to a client of the first system or a plurality of systems including clients having types the same as those of the clients of the first system. At this time, a sequence number of a data packet is ‘x+1’ as shown in FIG. 6. Thereafter, the RUMP 11 of the first system 10 transfers a data packet having a sequence number ‘x+2’ in step 213. In addition, if a predetermined SR packet transmission time reaches while transferring data packets, the RUMP 11 of the first system 10 transfers an SR packet in step 215. That is, an RUMP of a transmitting system periodically transfers the SR packet while transferring data packets. The SR packet notifies an RUMP of a receiving system of sequence numbers of data packets, which have been transferred by the RUMP of the transmitting system, and the number of the data packets.

As described above, the SR packet, which has been transferred from the transmitting system to the receiving system in step 215, includes sequence number information of the data packets which have been transferred and the number of the data packets which have been transferred. In FIG. 6, since the data packets, which have been transferred from the transmitting system to the receiving system, are not lost, next sequence number information ‘x+3’ included in the SR packet is identical to a sequence number of a data packet to be received by the receiving system. In addition, the number of transferred data packets included in the SR packet ‘2’ is identical to the number of data packets received by the receiving system 20 because the receiving system 20 receives two data packets having sequence numbers ‘x+1’ and ‘x+2’.

Also, the second system 20 transfers an RR packet to the first system in response to the SR packet which has been received. The RR packet notifies the RUMP of the transmitting system of information such as a sequence number of a data packet which has been received by the RUMP of the receiving system, a sequence number of the receiving system and UDP data receiving states.

As described above, the RR packet, which has been transferred from the transmitting system to the receiving system, has information such as a next sequence number included in the received SR packet and data receiving states in step 217.

A first field of the RR packet represents a next sequence number of the second system. At this time, the next sequence number is decided while creating the group list as described in the handshake mechanism. That is, when the second system sends data to the first system, next RR packets may have sequence numbers such as ‘y+1’, ‘y+2’, and so forth according to the number of packets transferred from the second system to the first system. In FIG. 6, the second system is reported by the SR packet that two packets are received from the first system and that a next sequence number included in the SR packet is ‘x+3’. The RUMP of the second system responds to the SR packet by using an RR packet representing that a sequence number of the second system is ‘y’ and an ACK sequence number is ‘x+3’. At this time, since data packets are not lost, a WLSN (Windows Lowest Sequence Number) and an BITMAP are set as ‘0’. If the transmitting system does not receive the RR packet from the receiving system after sending the SR packet, the transmitting system retransmits SR packets on every expiry of SRRT until the established ‘maximum SR retransmission’ times count is reached.

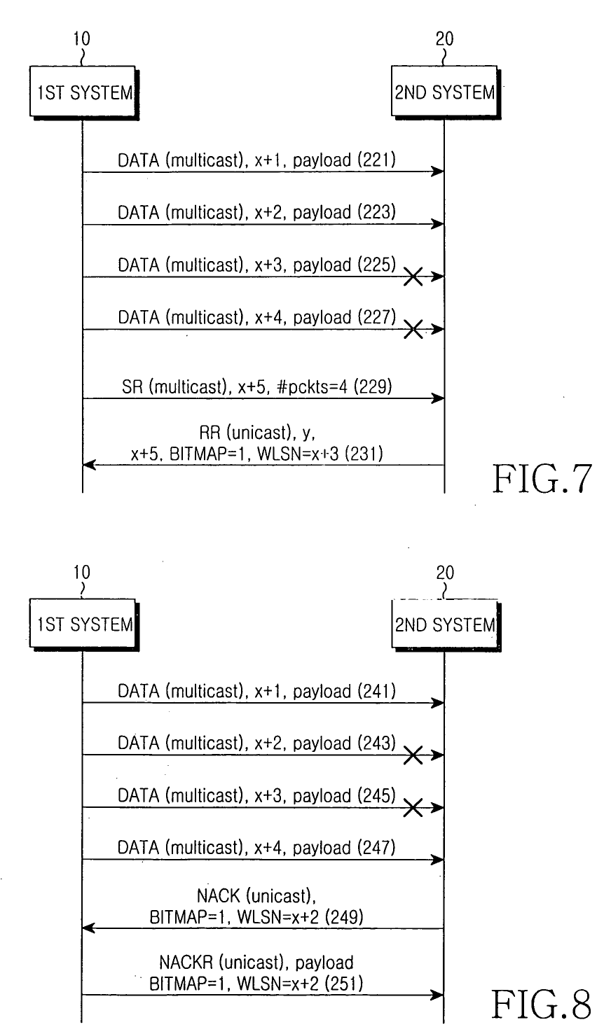

As described above, the first case representing that packets are not lost between RUMP peers on systems has been explained. Next, two cases wherein packets have been lost between RUMP peers on the first system and the second system will be described with reference to FIGS. 7 and 8. Hereinafter, a case showing that some of last packets have been lost between RUMP peers on the first system and the second system during multicast transmission will be described with reference to FIG. 7.

FIG. 7 is a diagram showing a procedure for confirming a packet loss by an SR packet transferred from the first system. Referring to FIG. 7, the RUMP 11 of the first system 10 transfers a data packet to an RUMP of a related client through the multicast transmission in step 221. At this time, a sequence number of the data packet is ‘x+1’ as shown in FIG. 7. Thereafter, the RUMP 11 of the first system 10 transfers a data packet having a sequence number ‘x+2’ in step 223. Also, it is assumed that although the RUMP 11 of the first system 10 transfers data packets with sequence numbers ‘x+3’ and ‘x+4’ through the multicast transmission in step 225 and step 227, the second system does not receive the data packets having the sequence numbers ‘x+3’ and ‘x+4’, which have been transferred before transferring an SR packet, among data packets which have been transferred by the first system.

In addition, as described above, the first system periodically transfers an SR packet. The SR packet, which is transferred from the first system to the second system through the multicast transmission, reports that four packets, which have been sent from a client corresponding to a transferred client identification, are transferred to the second system and a sequence number of a next multicast packet to be transferred is ‘x+5’ in step 229. The RUMP of the second system transfers an RR packet as a response to the SR packet to the first system in step 231. The RR packet reports that a sequence number of the second system is ‘y’ and an ACK sequence number corresponding to the received SR packet is ‘x+5’. At this time, since two packets are lost, a WLSN (Windows Lowest Sequence Number) is set as ‘x+3’ and a BITMAP positioned corresponding to the lost packets is set as ‘1’. That is, the WLSN represents a sequence number of the first lost packet in a receiver window. Furthermore, the BITMAP represents a window buffer of the receiver, wherein a value 1 of the bitmap represents the lost packet. If the first system 10 does not receive the RR packet within a predetermined time after transferring the SR packet, the first system 10 retransmits SR packets on every expiry of SRRT until the established ‘maximum SR retransmission’ count is reached.

Hereinafter, a case in which packets between the first packet and the last packet are lost even though the first packet and the last packet have been received between RUMP peers on the first system and the second system will be described with reference to FIG. 8.

FIG. 8 is a diagram showing a procedure for confirming a packet loss through a sequence number of a data received from the first system. Referring to FIG. 8, the RUMP 11 of the first system 10 sequentially transfers data packets having sequence numbers ‘x+1’, ‘x+2’, ‘x+3’, and ‘x+4’ through the multicast transmission in steps 241, 243, 245, and 247. At this time, a sequence number of an initial data packet is ‘x+1’ as shown in FIG. 8. It is assumed that although the second system receives the data packets with the sequence numbers ‘x+1’ and ‘x+4’ among four data packets transferred by the first system, the second system does not receive the data packets with the sequence numbers ‘x+2’ and ‘x+3’ between the data packets with the sequence numbers ‘x+1’ and ‘x+4’. The second system 20 performs a polling for a receiver window and compares the sequence numbers with each other so as to detect the number of lost packets before receiving the SR packet from the first system 10. Thereafter, the second system 20 sends an NACK packet to the first system 10. At this time, the polling is performed with respect to the receiver window with a predetermined period. The predetermined period is adjusted in order to obtain suitable reliability parameters. Accordingly, the second system compares the sequence numbers with each other by periodically performing the polling with respect to the receiver window. If data packets are lost, the second system transfers the NACK packet when the RWPT expires. Since two packets are lost, a WLSN (Window Lowest Sequence Number) included in the NACK packet is represented as ‘x+2’, which is a sequence number of an initial loss data packet. Also, the BITMAP positioned corresponding to the lost packets is represented as ‘1’. Furthermore, the BITMAP represents a receiver window buffer. A value ‘1’ of the bitmap represents the lost packet.

The RUMP 11 of the first system 10 transfers an NACKR packet to the second system 20 in response to the NACK packet from the second system. At this time, the NACKR packet includes an WLSN and a BITMAP in order to represent information about a data payload to be transferred. Accordingly, the WLSN and the BITMAP included in the NACKR packet are represented as ‘x+2’ and ‘1’, respectively.

Also, if the second system does not receive the NACKR packet after transferring the NACK packet to the first system, the second system retransmits NACK packets on every expiry of NACKRT until the ‘maximum NACK retransmission’ count is reached”. As described above, the three cases for the multicast transmission have been explained. Hereinafter, cases showing the unicast transmission will be described.

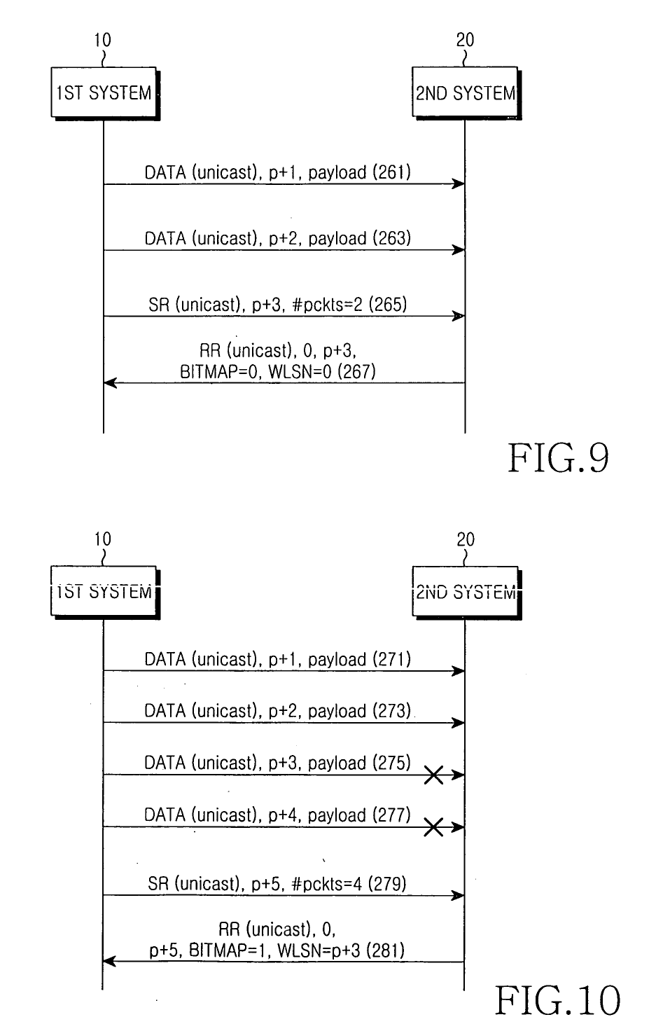

Hereinafter, the unicast transmission will be described similarly to the multicast transmission. There are three cases showing transmission of a packet having a payload under a condition representing that RUMP peers are registered with each other by a handshake mechanism between the RUMP peers. A first case shows that packet loss does not occur while transferring the packet between the RUMP peers, a second case shows that packet loss is confirmed by an SR packet transferred from the first system, and a third case shows that packet loss is confirmed by a sequence number of a data received from the first system. Hereinafter, unicast transmission procedures to be explained below are similar to multicast transmission procedures. Therefore, the redundant description of the unicast transmission procedures will be omitted. First, a case in which a packet loss does not occur while transferring the packet between the RUMP peers will be described with reference to FIG. 9.

FIG. 9 is a diagram showing the unicast transmission procedures when a packet loss does not occur and showing that the SR packet and the RR packet are exchanged between the RUMP peers on the first system and the second system.

Referring to FIG. 9, the first packet 10 transfers data packets with sequence numbers ‘p+1’ and ‘p+2’ to the second system in steps 261 and 263. Also, the first system 10 transfers the SR packet to the second system in step 265. The SR packet transferred from the first system reports that two packets have been transferred to the second system and a sequence number of a next unicast packet to be transferred is ‘p+3’. At this time, the first system 10 periodically transfers SR packets on every expiry of SRT. Thereafter, the RUMP of the second system replies with an RR packet representing that a next sequence number is ‘0’, which is a value established for the unicast transmission, and ACK sequence number is ‘p+3’ in step 267. In addition, since there is no packet loss, a WLSN (Windows Lowest Sequence Number) and a BITMAP are represented as ‘0’.

At this time, if the first system 10 does not receive the RR packet, the first system 10 retransmits SR packets on every expiry of SRRT until the ‘maximum SR retransmission’ count is reached.

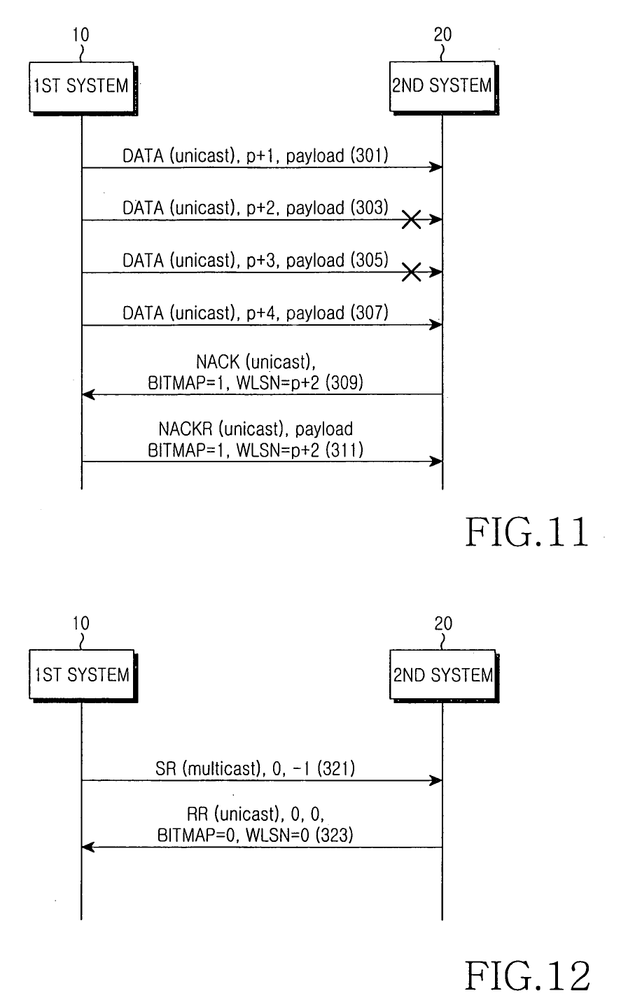

As described above, the first cases representing that packets are not lost between the RUMP peers on systems have been explained. Next, two cases showing that packets have been lost between the RUMP peers on the first system and the second system will be described with reference to FIGS. 10 and 11. Hereinafter, a case showing that some of last packets have been lost between the RUMP peers on the first system and the second system during unicast transmission procedure will be described with reference to FIG. 10.

Referring to FIG. 10, the first system 10 transfers data packets with sequence numbers ‘p+1’, ‘p+2’, ‘p+3’, and ‘p+4’ to the second system 20 through the unicast transmission in steps 271, 273, 275, and 279. Also, the first system 10 transfers an SR packet to the second system 20 through the unicast transmission in step 279. The SR packet from the first system 10 notifies the second system 20 that four packets have been transferred and a sequence number of a next unicast packet to be transferred is ‘p+5’.

The RUMP of the second system 20 transfers an RR packet as a response to the SR packet the first system 10 through the unicast transmission in step 281. The RR packet reports that a next sequence number is ‘0’, which is a value established for the unicast transmission, and an ACK sequence number is ‘p+5’. In addition, since an initial data packet, which is not received, has a sequence number thereof ‘p+3’ as shown in FIG. 10, a WLSN (Windows Lowest Sequence Number) is represented as ‘p+3’ and a BITMAP positioned corresponding to lost packets is represented as ‘1’. In other words, the WLSN represents a sequence number of a first data packet which is not received in the receiver window. Also, it is assumed that the BITMAP represents the receiver window buffer as described above and can represent 32 lost packets.

Next, a case representing that packet loss is confirmed by a sequence number of a data received from the first system will be described with reference to FIG. 11.

Referring to FIG. 11, the RUMP 11 of the first system 10 transfers data packets with sequence numbers ‘p+2’, ‘p+2’, ‘p+3’, and ‘p+4’ to the second system 20 through the unicast transmission in steps 301, 303, 305, and 307. Accordingly, the RUMP 21 of the second system 20 receives data packets transferred from the RUMP 11 of the first system 10 through the unicast transmission. It is assumed that although the RUMP 11 of the second system receives data packets with an first sequence number ‘p+1’ and a sequence number ‘p+4’ among data packets transferred from the first system, data packets with sequence numbers ‘p+2’ and ‘p+3’ between the data packets with the sequence numbers ‘p+1’ and ‘p+4’ are not received. Then, the second system 20 can detect the number of lost packets by performing a polling for a receiver window and comparing the sequence numbers with each other before receiving the SR packet from the first system 10. That is, the second system 20 can detect that the data packets with sequence numbers ‘p+2’ and ‘p+3’ are not received on the basis of the data packets with sequence numbers ‘p+1’ and ‘p+4’ received from the first system. Accordingly, the second system 20 transfers the NACK packets for requesting the data packets which are not received to the first system 10 in step 309. At this time, the polling is performed with respect to the receiver window with a predetermined period. The predetermined period is adjusted in order to obtain suitable reliability parameters. Accordingly, the second system 20 periodically performs the polling with respect to the receiver window. If data packets are lost, the second system transfers the NACK packet when the RWPT expires. Since two packets are lost, a WLSN (Window Lowest Sequence Number) included in the NACK packet is represented as ‘p+2’ and a BITMAP value of positions corresponding to loss data packets is represented as ‘1’. That is, the WLSN represents a sequence number of the first lost data in the receiver window. Furthermore, BITMAP represents a state of a receiver window buffer. A value ‘1’ in bitmap represents the lost data packet.

The RUMP 11 of the first system 10 transfers an NACKR packet as a response to the NACK packet, which is transferred from the second system, to the second system 20 in step 311. At this time, the NACKR packet includes an WLSN and a BITMAP in order to represent information about data payload to be transferred. Accordingly, the WLSN and the BITMAP of the NACKR packet are represented as ‘p+2’ and ‘1’, respectively.

Also, if the second system does not receive the NACKR packet after transferring the NACK to the first system, the second system retransmits the NACK packet on every expiry of NACKRT until the ‘maximum NACK retransmission’ count is reached.”

Meanwhile, a series of sequence numbers used for multicast packets is different from a series of sequence numbers used for unicast packets. That is, in case of the unicast transmission, different sequence numbers are used for different destinations. In case of the multicast transmission, one sequence number series is used for all destination terminals of clients included in the same group representing the same client identifications. In contrast, in case of the unicast transmission, each of different sequence number series is used for each of destination terminals. Therefore, in case of the unicast transmission, if the sequence number is applied to a receiving system, it is not required to transmit the sequence number. To this end, 32 bits of a sequence number field are divided into two parts in order to easily use sequence numbers of the unicast packets different from sequence numbers of the multicast packets. A first bit is used for deciding whether a sequence number of a packet is a multicast sequence number or an unicast sequence number. Remaining 31 bits are used for representing the sequence number of the packet.

Also, after the multicast or the unicast transmission has been achieved, a client shutdown process between RUMP peers on the first system and the second system will be described with reference to FIG. 12.

Referring to FIG. 12, the RUMP 11 of the first system 10 first starts a shutdown process for a client upon receiving a down signal from the client. When the clients 12 and 13 deactivate from the first system 10, the clients 12 and 13 transfer corresponding deactivation signals to the RUMP 11. At this time, the RUMP 11 uses an SR packet and an RR packet in order to perform the shutdown process.

Referring to FIG. 12, if the RUMP 11 of the first system 10 receives a deactivation signal from a predetermined client, the RUMP 11 of the first system 10 transfers the SR packet to the RUMP 21 of the second system through the multicast transmission in step 321. At this time, a next sequence number included in the SR packet is set as ‘0’ and the number of packets included in the SR packet is set as ‘−1’. At this time, the number of packets ‘−1’ and a next sequence number ‘0’ represent the shutdown process. The RUMP 21 of the second system 20 transfers the RR packet as a response to the SR packet received from the first system 10 through the unicast transmission in step 323. Although the first system performs the multicast transmission, systems receiving multicast packets transfer responses to a multicast system through the unicast transmission. In the RR packet, a next sequence number is set as ‘0’ and an ACK sequence number is set as ‘0’, which is a value of a next sequence number included in the SR packet received from the first system. In addition, a value of a BITMAP included in the RR packet is set as ‘0’ and a value of a WLSN included in the RR packet is set as ‘0’.

Meanwhile, in case of the unicast transmission, data packets are transferred to one destination. However, in case of the multicast transmission, data packets are transferred to a destination group. Accordingly, the RUMP according to the present invention supports “group list creation” in order to provide reliability of the multicast transmission.

Hereinafter, the multicast transmission or the unicast transmission described above will be described together with a buffer in detail.

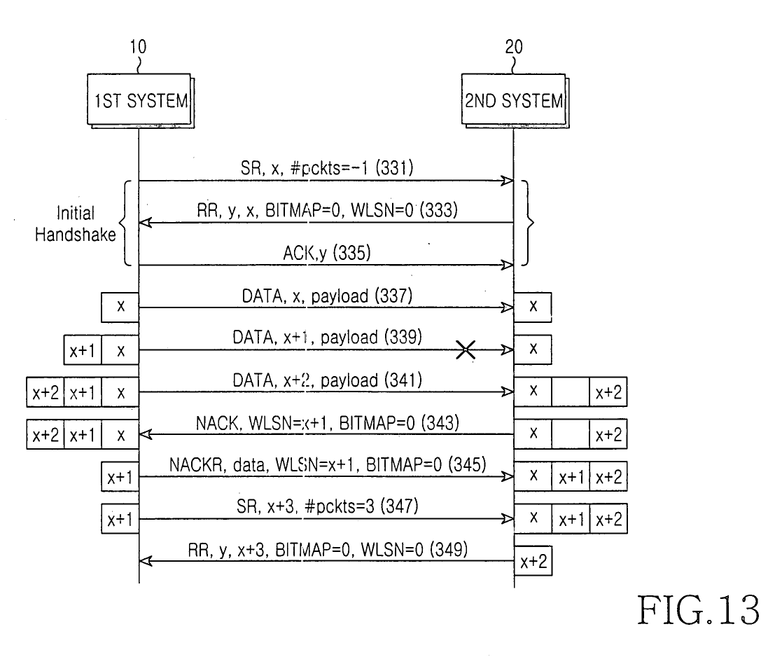

FIG. 13 is a diagram showing data transmission procedures between systems when a lost packet is one.

Referring to FIG. 13, a handshake mechanism has been first achieved between the first system 10 and the second system. The handshake mechanism has been described in detail with reference to FIG. 5.

The first system 10 transfers an SR packet for the handshake mechanism to the second system 20 in step 331. In a registration procedure, the number of packets included in the SR packet is set as ‘−1’. In addition, the second system 20 transfers an RR packet as a response to the SR packet for the handshake mechanism in step 333. Also, the first system transfers an ACK packet as a response to the RR packet in step 335, so that the handshake mechanism has been finished. If the handshake mechanism has been finished, the first system and the second system have been registered with each other, so that the first system and the second system can transfer data packets including payloads to each other.

Thereafter, the first system 10 transfers data packets with sequence numbers ‘x’, ‘x+1’, and ‘x+2’ to the second system in steps 337 to 341. Also, before receiving the SR packet from the first system 10, the second system detects the number of lost packets by performing a polling for a receiver window and comparing the sequence numbers with each other. Thereafter, the second system transfers an NACK packet to the first system 10 in step 343. The NACK packet includes WLSN (Window Lowest Sequence Number) information and BITMAP information. Since the second system 20 does not receive a data packet with a sequence number ‘x+1’ from the first system 10, the WLSN is set as ‘x+1’ and a BITMAP positioned corresponding to the lost packet is set as ‘1’. Therefore, the value of the BITMAP=0 (step 343) represents x+1 as lost packet and x+2 as received packet.

Also, if the first system 10 receives the NACK packet from the second system 20, the first system 10 transfers an NACKR packet including the lost packet to the second system in step 345. In addition, the first system 10 transfers an SR packet to the second system in step 347. A next sequence number is set as ‘x+3’ and the number of packets is set as ‘3’ in the SR packet. If the second system 20 receives the SR packet, the second system transfers an RR packet in step 349. The RR packet reports that a sequence number thereof is y and an ACK sequence number is x+3 to the first system 10. Thereafter, after receiving the NACK packet and the RR packet, a transmission window of the first system 10 is removed for the ACK packet. The second system 20 removes a receiver buffer after transferring the RR packet.

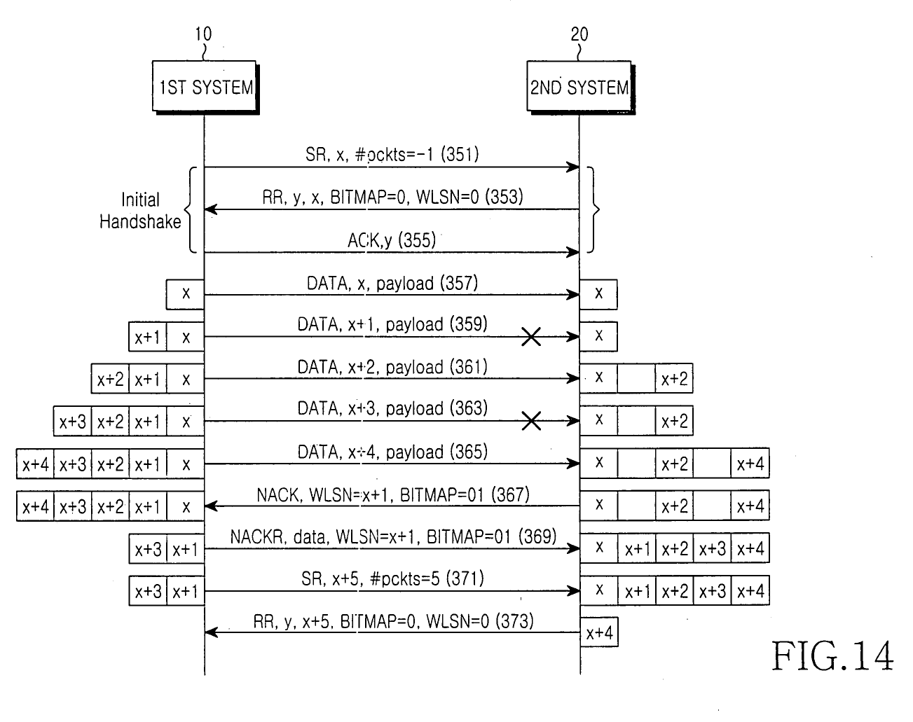

FIG. 14 is a diagram showing data transmission procedures between systems and showing that a plurality of packets are lost.

Referring to FIG. 14, a handshake mechanism has been first achieved between the first system 10 and the second system. The handshake mechanism has been described in detail with reference to FIG. 5. Since handshake mechanism (steps 351, 353, and 355) shown in FIG. 14 is the same as the handshake mechanism (steps 331, 333, and 335) shown in FIG. 13, redundant expression will be omitted.

If the handshake mechanism (step 351, 353, and 355) has been finished, the first system and the second system have been registered with each other, so that the first system and the second system can transfer data packets including payloads to each other. The first system 10 transfers data packets with sequence numbers ‘x’ to ‘x+4’ to the second system in steps 357 to 365. Also, before receiving the SR packet from the first system 10, the second system detects the number of lost packets by performing a polling for a receiver window and comparing the sequence numbers with each other. Thereafter, the second system transfers an NACK packet to the first system 10 in step 367. The second system 20 does not receive data packets with sequence numbers ‘x+1’ and ‘x+3’. Accordingly, in the NACK packet including an WLSN (Window Lowest Sequence Number) and a BITMAP, the WLSN is set as ‘x+1’ and a BITMAP value positioned corresponding to lost packets is set as ‘1’. The first system 10 transfers an NACKR packet including lost packets as a response to the NACK to the second system in step 369. In the NACKR packet including WLSN information and bitmap information, WLSN information and bitmap information ‘x+1’and ‘01’ represent x+1 and x+3 as lost packet and x+2 as received packet respectively. That is, WLSN information ‘x+1’ represents x+1 as lost packet, and the first bit of the bitmap information ‘0’ represents x+2 as normal received bit, and the second bit of the bitmap information ‘1’ represents x+2 as lost bit. In addition, the first system 10 transfers an SR packet to the second system in step 371. A next sequence number is set as ‘x+5’ and the number of packets is set as ‘5’ in the SR packet. If the second system 20 receives the SR packet, the second system transfers an RR packet. The RR packet reports that a sequence number of the second system is y and an ACK sequence number is x+5 to the first system 10. Thereafter, since the second system has no lost packets because of re-transmitting data, BITMAP information and WLSN information are set as ‘0’, respectively. Thereafter, the first system removes a transmission window for the ACK packet after receiving the NACK packet and the RR packet. The second system 20 removes a receiver buffer after transferring the RR packet.

As described above, the RUMP has an effect of assuring reliable packet transmission between systems over shared media (i.e., LAN) using an UDP as an transfer layer.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

1. A method for transferring connectionless-oriented data packets between systems connected to each other through shared media, the method comprising the steps of:
i) periodically transferring from a transmitting side of data packets an SR (Sender Report) packet, which includes information representing transmission data packets;
ii) determining if the data packets are lost based on the information of the SR packet if a receiving side of the data packets receives the SR packet from the transmitting side of the data packets, and transferring to the transmitting side of the data packets an RR (Receiver Report) packet, which includes information about a received data packet;
iii) periodically transferring an NACK (Negative. Acknowledgement) packet, which includes information relating to the received data packet, if lost packets exist after the receiving side of the data packets periodically polls a receiver window; and
iv) transferring to the receiving side of the data packets an NACKR (Negative Acknowledgement Reply) packet, which includes the lost data packets based on information of the NACK packet, if the transmitting side of the data packets receives the NACK packet from the receiving side of the data packets.

2. The method as claimed in claim 1, wherein the SR packet includes information of a next sequence number and a number of transferred packets.

3. The method as claimed in claim 1, wherein the RR packet includes information relating to a next sequence number, an ACK sequence number, a lowest sequence number of the receiver window which is not received, and a bitmap of received packets.

4. The method as claimed in claim 1, wherein the NACK packet includes information such as a lowest sequence number of the lost packets and a bitmask of a next lost packet.

5. The method as claimed in claim 1, wherein the NACKR packet includes a lowest sequence number of one of the retransmitted packets and a bitmask of a next retransmission packet.

6. An apparatus for transferring connectionless-oriented data packets between systems connected to each other through shared media, the apparatus comprising:
a control unit which manages transmitting states of clients depending on an activating state of the clients and transfers data to corresponding clients when fault of the data occurs;
a transmitting/receiving unit which is connected to the control unit and performs data communication between related clients;
an identification unit which detects the transmitting states of the clients and an identification of the clients based on the data communicated in the transmitting/receiving unit; and
a memory for storing client identification information depending on the activating state of the clients and initial sequence numbers related to data transmission with respect to each client.

7. The apparatus as claimed in claim 6, wherein the control unit transfers an SR (Sender Report) packet, which includes information of a sequence number of a next packet to be transmitted and a number of already transferred packets, when data packets are transmitted and received.

8. The apparatus as claimed in claim 6, wherein the control unit transfers an RR (Receiver Report) packet, which includes information regarding a next sequence number to be received by a transmitting side of the data packets, an ACK sequence number, a lowest sequence number of a receiver window which is not received, and a bitmap of received packets, when receiving the data packets.

9. The apparatus as claimed in claim 6, wherein the control unit periodically polls the receiver window and periodically transfers to the transmitting side of the data packets an NACK (Negative Acknowledgement) packet, which includes information about received data packets, if the lost data packets exist.

10. The apparatus as claimed in claim 9, wherein the NACK packet includes a lowest sequence number of one of the lost packets and a bitmask of a next lost packet.

11. The apparatus as claimed in claim 9, wherein a transmission apparatus of data packets, which receives the NACK packet from a receiving side of the data packets, transfers to the receiving side of the data packets an NACKR packet, which includes the lost data packet depending on information of the NACK packet.

12. The apparatus as claimed in claim 11, wherein the NACKR packet includes a lowest sequence number of one of retransmitted packets and a bitmask of a next retransmission packet.
